(19) United States
(12) Patent Application Publication
(10) Pub. No.: US 2009/0299846 A1
(43) Pub. Date: Dec. 3, 2009

(54) Linking loyalty reward programs

(76) Inventors: Wayne Richard Brueggemann, Woodstock, GA (US); Ramkishan Sadasivam, Suwanee, GA (US); Kurt Emmenegger, Marietta, GA (US); Ashish Bhagare, Cumming, GA (US); Deirdre Baker, Alpharetta, GA (US)

Correspondence Address: KING & SPALDING, 1180 PEACHTREE STREET , NE, ATLANTA, GA, 30309-3521, US

(21) Appl. No.: 12/381,927

(22) Filed: Mar. 18, 2009

Related U.S. Application Data
(60) Provisional application No. 61/128,328, filed on May 21, 2008.
(60) Provisional application No. 61/128,244, filed on May 20, 2008.
(60) Provisional application No. 61/069,999, filed on Mar. 18, 2008.

(51) Int. Cl. G06Q 30/00; G06Q 10/00; G06F 17/30

(52) U.S. Cl. 705/14.29; 705/14.28; 705/14.33; 707/104.1; 707/E17.044

(57) ABSTRACT

Linking loyalty programs by use of a new and unique cross-reference number. Reward points from the linked accounts are pooled. Redemption of reward points associated with the linked accounts can be restricted using restriction rules. Restriction rules restrict redemption of points from an individual's account; from the pooled rewards, and/or restrict redemption for a predetermined reward type. Reward points in the linked accounts can also be converted from one reward account to another using a conversion table, which holds a liability ratio for each account. A processing platform, typically comprising a computer-implemented linking engine and an account files database, is logically connected to a network to receive linking instructions from an account holder. The linking engine can assign the cross-reference number; apply restriction rules; and convert reward points using the conversion tables.

### STATEMENT OF RELATED PATENT APPLICATIONS

This non-provisional patent application claims priority under 35 U.S.C. § 119 to U.S. Provisional Patent Application No. 61/128,328, titled Method and System for Linking Loyalty Programs, filed May 21, 2008; U.S. Provisional Application No. 61/128,244, titled Method and System for Rewards Transfer Program, filed May 20, 2008; and to U.S. Provisional Application No. 61/069,999, titled System and Method for Relationship Rewards Program, filed Mar. 18, 2008. These provisional applications are hereby fully incorporated herein by reference.

### FIELD OF THE INVENTION

This invention relates to linking loyalty reward accounts. More particularly, this invention relates to linking related reward accounts to allow for pooling of rewards; restricting the ability to redeem reward points from the linked accounts; and efficiently converting reward program points from one loyalty reward program to another.

### BACKGROUND OF THE INVENTION

Loyalty reward programs offer users the ability to accumulate reward points as an incentive for using certain credit cards, making certain purchases, or frequenting certain merchants, such as airlines, restaurants, and hotels. For example, a loyalty reward program can provide reward points for each purchase made, i.e. 1 point for each dollar spent overall on a particular credit card, and 2 points for each dollar spent for travel. The reward points typically accumulate in a loyalty reward program, such as a frequent flier, or a hotel rewards program. Reward points can then be redeemed for reward offerings, such as air travel, hotel stays, gift certificates, and the like.

Often, a reward account holder is associated with multiple financial accounts which are associated with a particular loyalty reward program. For example, in a family situation, a mother and father may have a credit card which earns LOYALTY PROGRAM A” points, while a son or daughter may have a debit card account which also earns “LOYALTY PROGRAM A” points. The family may wish to pool their “LOYALTY PROGRAM A” reward points. The term “pooling” is used herein to describe combining the balances of reward points from each of these associated financial accounts, for example, the separate accounts held by family members. Conventional systems, however, do not provide an efficient way of linking financial accounts for this purpose. The family members have different social security numbers, and frequently have different names and addresses. Thus, it is difficult to link financial accounts based on a particular piece of data, such as last name and/or address. In that regard, a need exists in the art for an efficient way to link associated accounts.

Further, conventional systems do not offer a method to restrict access to reward points. For instance, even if reward pints can be pooled, all reward account holders can redeem the pooled rewards without restriction in the conventional system. Thus, a need also exists in the art to restrict access to both individual rewards and to pooled rewards once the associated accounts are linked.

Moreover, it is often the case that an account holder desires to convert reward points from one reward program to another. For example, a user may wish to convert “LOYALTY PROGRAM A” points to “LOYALTY PROGRAM B” points. However, because the point earnings and values are different between reward programs, i.e. 1 “LOYALTY PROGRAM A” point does not necessarily translate to 1 “LOYALTY PROGRAM B” reward point, it is difficult and complex to make such conversions. Furthermore, financial card issuers frequently offer different types of reward programs, and account holders may need to convert reward points among the different programs. Conventional methods for conversion may not recognize the differences between the reward programs, making conversion difficult. Moreover, the user making the conversion is often not apprised of the resulting amount of reward points after the conversion. Thus, the user is unaware whether the conversion is worthwhile. Thus, a need exists in the art for a user-friendly, streamlined method to convert rewards from one program to another.

### SUMMARY OF THE INVENTION

The invention implements linking loyalty programs that allow loyalty reward account holders to link related accounts, place restriction rules on those linked accounts which can determine how any of the linked account holders can redeem reward points from the linked accounts, and convert reward points in the linked accounts or non-linked accounts from one loyalty reward program to another. Loyalty reward accounts can be “linked” by associating the accounts with a new and unique cross-reference number. Reward points from the linked accounts can be pooled by combining the point balance for each linked account into a single balance representing a sum or total of the reward point balances. From the pool of linked accounts, one of the accounts designated as the pool manager can restrict another account holder's ability to redeem reward points from the linked accounts by setting restriction rules. Restriction rules can restrict redemption from the individual's account or from the pooled rewards. Reward points in the linked accounts can also be converted from one reward account to another using a conversion table, which holds a liability ratio for each account.

One aspect of the invention provides a method for linking loyalty reward accounts including the steps of: (a) receiving, by a linking engine, instructions from a loyalty reward account holder, the instructions including a selection of loyalty reward accounts; (b) validating, by the linking engine, the loyalty reward account holder's access to the loyalty reward accounts; (c) in response to validating the loyalty reward account holder's access, assigning, by the linking engine, a new and unique cross-reference number to the loyalty reward accounts; (d) storing the cross-reference number in association with each of the loyalty reward accounts in a database; (e) pooling reward points associated with the loyalty reward accounts; and (f) providing access to the cross-reference number to a loyalty reward program provider. The linking engine can be implemented by a computer system having one or more processors logically connected to one or more memory storages devices, each processor operable to execute instructions stored in the memory storage devices.

Another aspect of the invention provides a method for linking loyalty reward accounts including the steps of: (a) receiving, by a linking engine, a selection of loyalty reward accounts; (b) assigning, by the linking engine, a new and unique cross-reference number to the loyalty reward accounts, where the loyalty reward accounts associated with the new and unique cross-reference number are linked accounts; (c) storing the cross-reference number in association with the loyalty reward accounts in a database; (d) pooling reward points associated with the loyalty reward accounts, where pooling includes combining a balance of reward points associated with each of the linked accounts; and (e) providing access to the cross-reference number to a loyalty reward program provider.

Yet another aspect of the invention provides a system for linking loyalty reward accounts which comprises: a linking engine and an account files database, logically connected to the linking engine. The linking engine is operable to: (a) assign a new and unique cross-reference number to loyalty reward accounts, where the loyalty reward accounts associated with the new and unique cross-reference number are linked accounts; (b) apply a restriction rule during a reward redemption associated with one or more of the linked accounts; and (c) convert, using one or more liability ratios, an amount of reward points associated with the linked accounts from a one loyalty reward program to another. The account files database can (a) store the new and unique cross-reference number in association with the linked accounts; (b) store the restriction rule; and (c) store a conversion table, the conversion table comprising the liability ratio for each of the loyalty reward accounts.

### BRIEF DESCRIPTION OF THE DRAWINGS

FIG. 1 depicts a system architecture in accordance with an exemplary embodiment of the present invention.

FIG. 2 depicts an overall process flow diagram for linking reward accounts in accordance with an exemplary embodiment of the present invention.

FIG. 3 depicts a detailed process flow diagram for linking reward accounts using a cross-reference number in accordance with an exemplary embodiment of the present invention.

FIG. 4 depicts a detailed process flow diagram for creating restriction rules to restrict redemption from linked reward accounts in accordance with an exemplary embodiment of the present invention.

FIG. 5 depicts a detailed process flow diagram for converting reward points in accordance with an exemplary embodiment of the present invention.

FIG. 6 depicts a detailed process flow diagram for building conversion tables in accordance with an exemplary embodiment of the present invention.

### DETAILED DESCRIPTION OF THE EXEMPLARY EMBODIMENTS

Exemplary embodiments of the present invention are provided. Associated loyalty reward accounts can be linked using a new and unique cross-reference number. A “loyalty reward account” or “reward account” an account which collects reward points and is connected to a financial account, such as a credit or debit card. Reward points from the linked accounts are pooled. Redemption of reward points associated with the linked accounts can be restricted using restriction rules. Restriction rules can restrict redemption of points from an individual's account or from the pooled rewards, and/or restrict redemption for a predetermined reward type. Reward points in the reward accounts can also be converted from one reward account to another using a conversion table, which holds a liability ratio for each account. A processing platform, which typically includes a linking system, is logically connected to a network to receive linking instructions from an account holder. The processing platform also can include a linking engine, which is logically connected to an account files database. The decision engine assigns the cross-reference number; applies restriction rules; and converts reward points using the conversion tables.

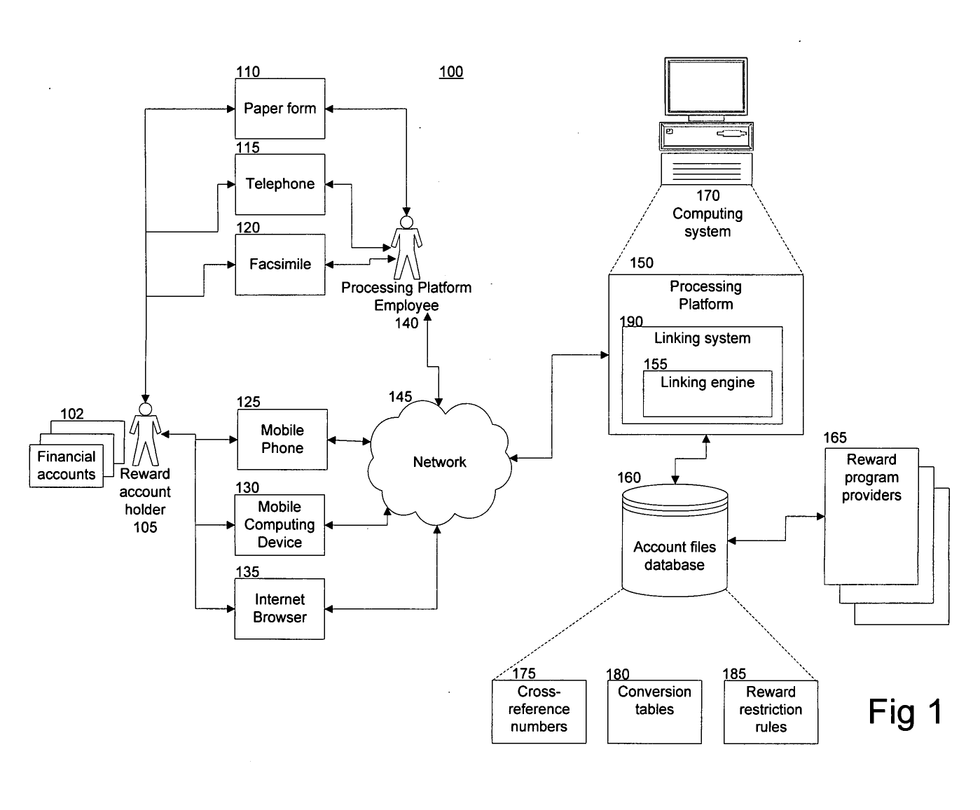

FIG. 1 depicts a system architecture 100 in accordance with an exemplary embodiment of the present invention. Referring to FIG. 1, the exemplary architecture 100 includes a network 145, a processing platform 150, a linking engine 155, and an account files database 160. The system 100 can be implemented with conventional information technology components, including computers, computer networks, software programs, databases and communications devices,

The processing platform 150 can resides on a computing system 170, where the computer has a memory, a processor, and an interface. It will be appreciated to those skilled in the art that one or more of the steps described herein and illustrated in the appended flowcharts may be performed by computer hardware, software, or a combination thereof, as may be embodied in one or more computing systems. However, it should be apparent that there could be many different ways of implementing the embodiments of the present invention with the support of one or more computer programs that are typically stored in a computer-readable memory storage device and comprise computer-executable instructions. The implementation of these embodiments should not be construed as limited to any one set of computer program instructions or programming language. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention.

A reward account holder 105 is in communication with the processing platform 150 through means including a mobile phone 125, a mobile computing device 130, and an internet browser 145. Each of these devices can communicate via a network 145 with the processing platform 150. The network 145 is a communications network, such as a telecommunications network, computer network, or the Internet. In addition, the reward account holder 105 can communicate with a processing platform employee 140 via paper form 110, telephone 115, facsimile 120, and/or another form of communication. Through these communications mechanisms, the reward account holder 105 can communicate instructions for linking rewards accounts. The processing platform employee 140 can communicate these instructions to the processing platform 150 via the network 145 using, for example, a workstation.

The reward account holder 105 is a consumer, or entity, such as a business, that holds one or more financial accounts 102, such as a credit card, a debit card, a prepaid card, a home equity line of credit (“HELOC”), and another type of financial instrument. The financial accounts 102 are associated with one or more loyalty reward programs. A loyalty reward program is offered by one of the reward program providers 165. A “loyalty reward program” or “reward program” is used herein to describe an incentive system which allows a user to collect reward points (“points” is used herein to describe any type of reward increment, including miles) in return for making certain purchases, using a particular credit card, and/or frequenting certain merchants. The reward points can be redeemed for rewards, such as free travel, hotel stays, and the like, from the reward program providers 165.

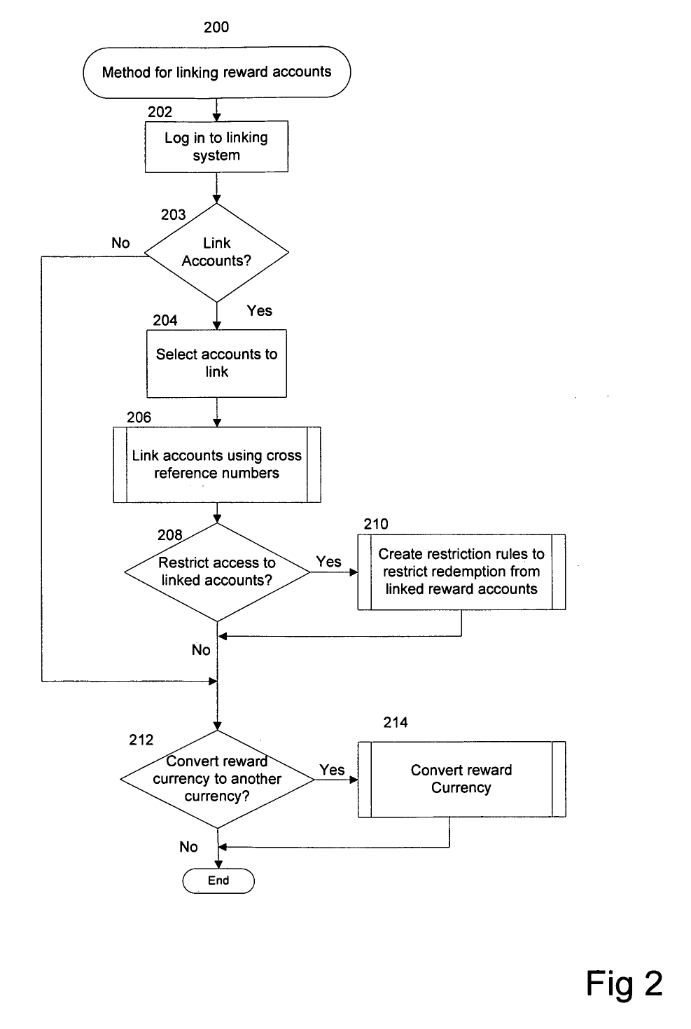

The reward account holder 105 can provide instructions on linking various reward accounts by communicating with the processing platform 150. For example, the reward account holder 105 can communicate instructions to link certain accounts; restrict access to accounts for certain users; and convert reward points from one loyalty program to another. These linking processes will be discussed in more detail herein with reference to FIGS. 2-6.

The processing platform 150 is an information technology framework, associated with the linking rewards process comprising one or more computers and memory storage devices, on which applications can be run and maintained. The processing platform 150 includes a linking system 190. The linking system 190 is an application that resides on the processing platform 150, and provides an interface for the reward account holder 105 to provide instructions relating to the linking functionality described herein. The linking system 190 includes a linking engine 155. The linking engine 155 is an application that receives the linking instructions from the reward account holder 105 and performs the resulting linking activity, i.e. linking financial accounts 102, applying restriction rules, and/or converting reward points. The linking engine 155, the linking system 190, and the processing platform 150 are in communication with the account files database 160, which is used to store the information related to the financial accounts 102 in the account files database 160. Information stored by the account files database 160 includes files for cross-reference numbers 175, conversion tables 180, and reward restriction rules 185.

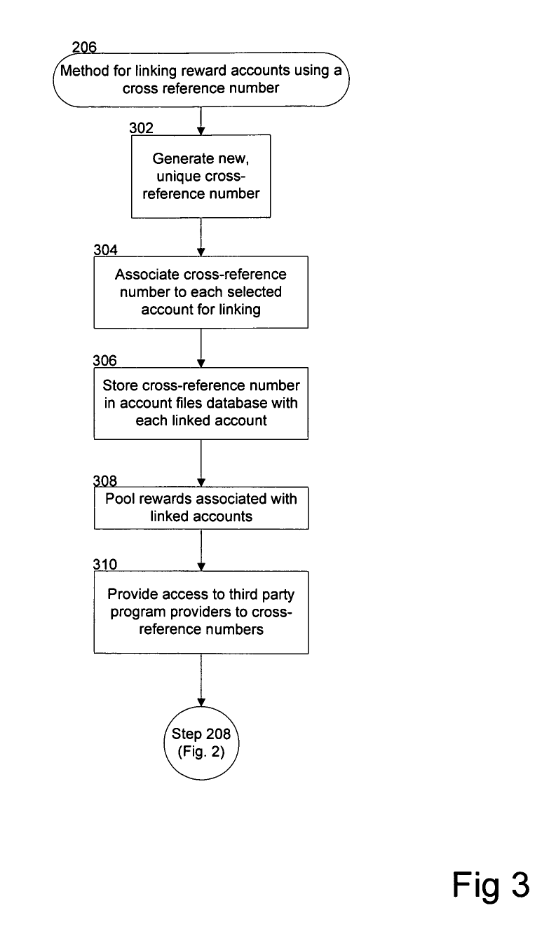

FIG. 2 depicts an overall process flow diagram 200 for linking reward accounts in accordance with an exemplary embodiment of the present invention. Referring to FIG. 1, a process for linking reward accounts can be described. FIGS. 3, 4 and 5, discussed in detail below, provide additional details on this overall process.

At step 202, the reward account holder 105 logs into a linking system 190 using information required to access the reward account holder 105's financial accounts 102. To log into the linking system, the reward account holder 105 may provide information related to one of his or her financial accounts 102, and/or may enter a predetermined log-in identification and password. As discussed herein with reference to FIG. 1, the reward account holder 105 can communicate with the processing platform 150 to log in to the linking system 190 using a variety of methods (i.e. mobile computing device 130, telephone 115). Once logged in, the linking system displays all relevant accounts associated with the reward account holder 105. For example, the displayed accounts can include not only the reward account holder 105's individual accounts, but their family members' accounts as well.

Accounts in a relationship share a common pool that is unique to the relationship. A “household” type relationship model, which is described in the example provided above, comprises linked accounts for family members, such as a spouse and children. In this model, a “parent” account operates as a Pool Manager Account, associated with a Pool Manager, to create the pool and add or “link” other “child” accounts for the relationship model. In the household-type relationship, for example, the Mother can act as the Pool Manager, by adding or linking the “child” accounts for family members—Father, Son and Daughter—to form a common pool of linked accounts.

A display of rewards for accounts in a relationship is managed by a system-generated key, also described as an identifier, to the common pool/relationship that is created at the time of establishing the relationship. When displaying the rewards for the parent account, the linking system locates the relationship/pool using the account's unique identifier and then determines the relationship/pool identifier. In turn, the linking system can retrieve the balances/rewards summary for all accounts that share the same relationship/pool identifier based on status.

At step 203, a inquiry is completed to determine if the reward account holder would like to complete an account linking activity. If so, the method continues to step 204; otherwise, the method proceeds to step 212.

At step 204, the reward account holder 105 selects accounts to link to one another. Reward accounts associated with each selected financial account can be linked in this step.

“Linking accounts” and “linked accounts” is used herein to describe associating different reward accounts such that the reward points accumulated for each of the reward accounts are pooled. “Pooled reward” points reflect the combined balance of reward points from the linked accounts. For example, within a family, the reward account holder mother may link her credit card to her daughter's debit card, such that rewards points accumulated on both cards are pooled together. As another example, a company manager may link the accounts of the company's employees, such that reward points accumulated by all of the employees, i.e. from business travel, are pooled together to reflect the company's pooled reward points.

At step 206, the linking engine 155 links the selected accounts using a cross-reference number. This linking process will be described in more detail herein with reference to FIG. 3.

At step 208, the reward account holder 105 makes a determination whether to restrict access to the linked accounts (which were linked in step 206 and described herein with reference to FIG. 3). For example, the reward account holder 105 may be a father who chooses to restrict his son from accessing pooled reward points.

If, at step 208, the reward account holder 105 makes the determination to restrict access to linked accounts, the method proceeds to step 210.

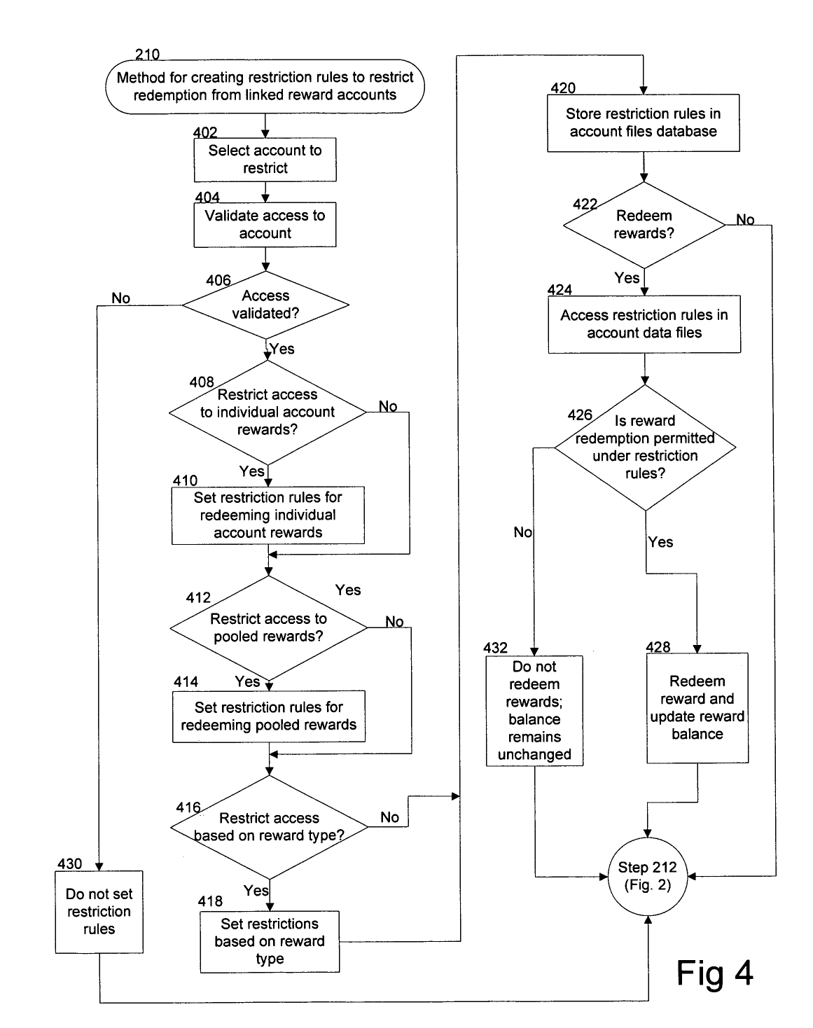

At step 210, the reward account holder 105 creates restriction rules which restrict access to the linked accounts. The process for creating restriction rules will be described in more detail herein with reference to FIG. 4.

At step 212, the reward account holder 105 makes a determination whether to convert a reward currency to another reward currency type. For example, the reward account holder 105 may want to convert airline bonus miles to hotel bonus points.

If, at step 212, the reward account holder 105 makes the determination to convert a reward currency, the method proceeds to step 214. Reward conversion can happen with or without linking of accounts, i.e. individual accounts can convert without the creation of linked accounts.

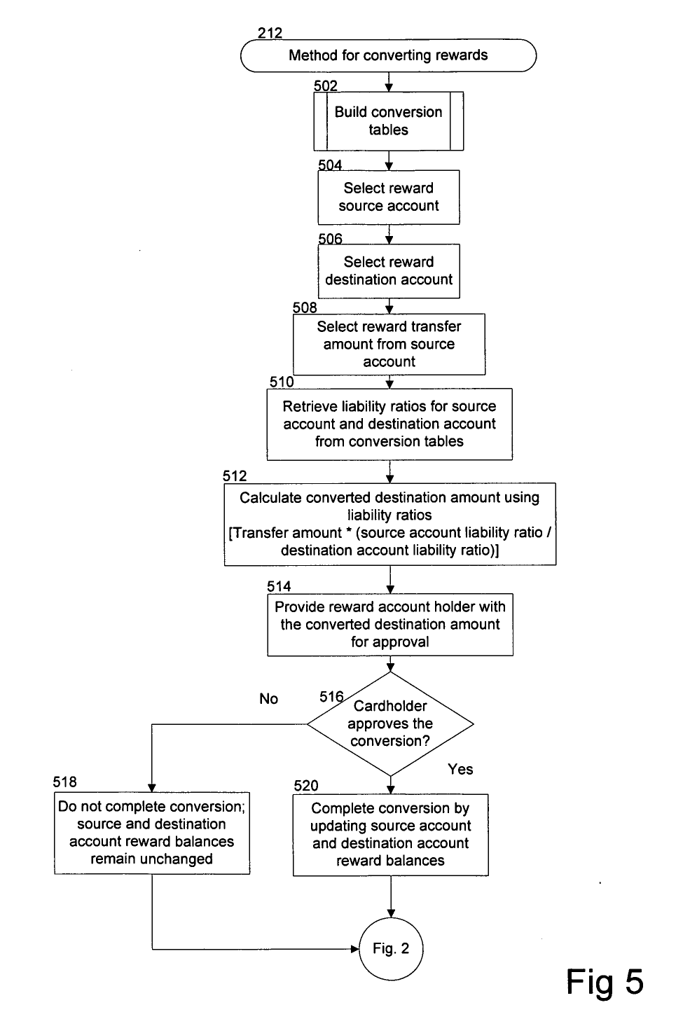

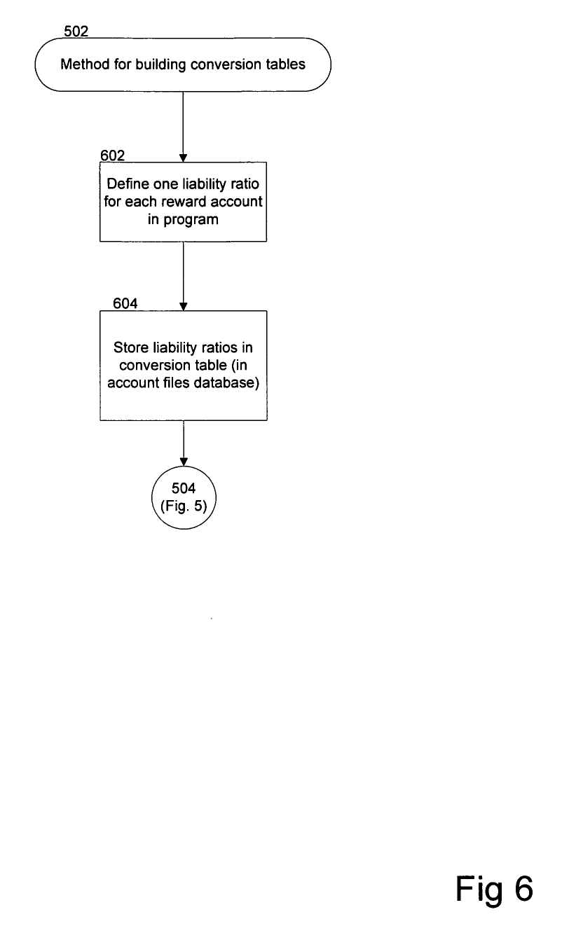

At step 214, the reward account holder 105 converts reward currency for one program to the currency of another reward program. The process for converting reward currency or “points” is described in more detail herein with reference to FIGS. 5 and 6. The method then ends at the End step.

Referring back to step 208, if the reward account holder 105 makes the determination not to restrict access to linked accounts, the method proceeds to step 212, and the method proceeds as described herein. If, at step 212, the reward account holder 105 makes the determination not to convert rewards currency from one loyalty program to another, the method then ends.

FIG. 3 depicts a detailed process flow diagram 206 for linking reward accounts using a cross-reference number in accordance with an exemplary embodiment of the present invention. Referring to FIGS. 1 and 3, a process for linking reward accounts using a cross-reference number can be described.

At step 302, the linking engine 155 generates a cross-reference number. The cross-reference number is new identifier—one that is not based on a social security number—and serves as unique identifier in comparison to other cross-reference numbers. This unique identifier can be generated using predetermined logic, based on attributes of the accounts that are being linked. In an exemplary embodiment, the new and unique cross-reference number is chosen sequentially, based on a previously assigned cross-reference number.

Accounts in a relationship typically share a common pool that is unique to the relationship. This unique key or identifier is generated and managed by the linking system. In an exemplary embodiment, the linking system uses the Persistence API to configure the unique key generation as shown below. In the alternative, a hashing algorithm could be used to generate a unique identifier for the common pool representing a relationship having linked accounts.

At step 304, the linking engine 155 associates the new, unique cross-reference number to the accounts selected for “linking.” Thus, the selected accounts are now “linked” because they are each associated with the same cross-reference number. As discussed above, reward points from linked accounts are aggregated or “pooled.” The concepts of linking and pooling are well known in the loyalty program field.

At step 306, the account files database 160 stores the cross-reference number (assigned at step 304) with each now linked account. The account files database 160 stores the cross-reference number in the file for cross-reference numbers 175.

At step 308, the linking engine 155 aggregates or “pools” reward points from the linked accounts. As discussed above, pooling accounts means to combine the balances of reward points from each of the linked accounts. Thus, after linking accounts, each reward account is not only associated with its individual reward account, but with the combined total of all of the linked accounts.

At step 310, the account files database 160 provides access to reward program providers 165 to obtain the cross-reference numbers. In this way, the reward program providers 165 can easily identify which accounts are linked (and therefore have pooled rewards). The method then proceeds to step 208 of FIG. 2, as previously described herein.

FIG. 4 depicts a detailed process flow 210 for creating restriction rules to restrict redemption from linked reward accounts in accordance with an exemplary embodiment of the present invention. Referring to FIGS. 1 and 4, a process for creating restriction rules to restrict access to linked reward accounts can be described.

At step 402, the reward account holder 105 selects an account to restrict using the interface of the linking system 190. The reward account holder 105 can select among linked accounts, which were linked at step 206 of FIG. 2 and were described herein with reference to FIG. 3. Restricting access to a reward account is used herein to describe placing restriction rules on a particular account holder's ability to redeem reward points from that account holder's account and/or from the pooled rewards. For example, a mother may prevent her son from redeeming pooled rewards, but may allow him to redeem individual rewards. Alternatively, she may set a reward point limit for redeeming pooled rewards. “Redeeming rewards” or a “reward redemption” is used herein to describe the process of receiving rewards, such as airline tickets, gift certificates, and the like, in exchange for reward points debited from the reward account.

At step 404, the linking engine 155 validates access to the selected account which the reward account holder 105 chose to restrict. The linking engine 155 can use the cross-reference numbers assigned to linked accounts (as described herein with reference to FIG. 3) to confirm whether the selected account is linked to the reward account holder 105, therefore providing the reward account holder 105 with appropriate ability to set restriction rules.

The linking engine determines which account holders are capable of setting restriction rules for other account holders. Each account in the relationship/pool has a set of flags/attributes that indicates the capabilities or authorities of the account. These flags can be modified only by the “parent” account, which is also referred to as the Pool Manager. A determination of which account can be a pool manager is typically completed by the financial institution that is responsible for the financial account. Table 1 provides a listing of exemplary account attributes for a representative account.

TABLE 1

| Attribute | | Possible values | |
|---|---|---|---|
| name | Attribute definition | (specify default value) | Behavior expected |
| Redeem flag | This attribute defines if the | Y/N (default defined by | If the account does not have redemption |
| | account has the ability to | the program's business | ability, then the available balance |
| | redeem any rewards or not | rules) | for redemption should be zero. |
| Pooled flag | This attribute defines if an | P = Pooled rewards | This flag can be set by the pool manager |
| | account has the ability to | I = Individual | for each account through the servicing |
| | access pooled rewards, | rewards balance | vendor website. In batch mode, these |
| | individual rewards or no | N = No rewards | values can be controlled by the program |
| | rewards | | manager, i.e., the financial institution |
| | | | associated with the account, and saved |
| | | | in the database. Point balance activity |
| | | | can refer to these flags during |
| | | | calculations. |

At step 406, the linking engine 155 determines whether the access to the selected account is valid, based upon the analysis performed at step 404.

If, at step 406, the linking engine 155 determines that the access to the selected account is valid, the method proceeds to step 408.

At step 408, the reward account holder 105 makes a determination whether to restrict access to an individual reward account.

If, at step 408, the reward account holder 105 makes the determination to restrict access to an individual reward account, the method proceeds to step 410.

At step 410, the reward account holder 105 sets a restriction rule for redeeming reward points from an individual reward account. For example, the reward account holder 105 can set a restriction rule which prevents another account holder associated with the linked accounts from redeeming their individual reward points. The restriction rule can restrict redemption in a variety of ways. For example, the restriction rule can prevent any redemption from the individual account; prevent redemption over a certain amount; and/or prevent redemption over a certain percentage of the balance, i.e., the account holder can only redeem half of their reward points.

At step 412, the reward account holder 105 makes a determination whether to restrict access to pooled rewards.

If, at step 412, the reward account holder 105 makes the determination to restrict access to pooled rewards, the method proceeds to step 414.

At step 414, the reward account holder 105 sets a restriction rule for redeeming pooled rewards. The restriction rule can restrict redemption in a variety of ways. For example, the reward account holder 105 can set a restriction rule which prevents another account holder from redeeming any pooled rewards, or may restrict access to a certain portion of the pooled rewards.

At step 416, the reward account holder 105 makes a determination whether to restrict access based on reward type.

If, at step 416, the reward account holder 105 makes the determination to restrict access based on reward type, the method proceeds to step 418.

At step 418, the reward account holder 105 sets a restriction rule based on reward type. For example, the reward account holder 105 can set a restriction rule which prevents another account holder from redeeming rewards for any reward product other than travel. For example, the reward account holder 105 may be a company manager, who can set a restriction rule which prevents an employee from redeeming reward points for leisure items rather than travel expenses.

At step 420, the linking engine 155 stores the restriction rules set in steps 410, 414, and 418 in the account files database 160, specifically, in the file for restriction rules 185. There, the restriction rules can be accessed when a reward account holder attempts to redeem rewards. Table 2 defines representative restriction rules for a set of linked accounts associated with a “household”-type relationship.

TABLE 2

| | | Reward | Restriction | Restriction | Restriction |
|---|---|---|---|---|---|
| Account | | Point | Rule for | Rule for | Rule for |
| Holder | Accounts | Balance | individual account? | pooled rewards? | reward type? |
| Husband | Credit | 12,000 | No - can | Yes - can only | Can only |
| | Card | | redeem | redeem up to | redeem for |
| | | | | 25,000 | travel |
| | Debit | 5,000 | No - can | No - can | No rule |
| | Card | | redeem | redeem | |
| Mother | Credit | 2,000 | No - can | No - can | No rule |
| | Card | | redeem | redeem | |
| | Debit | 15,000 | No - can | No - can | Can only |
| | Card | | redeem | redeem | redeem at |
| | | | | | restaurants |
| | HELOC | 10,000 | No - can | Yes - can not | No rule |
| | | | redeem | redeem | |
| Son | Debit | 4,000 | Yes - cannot | Yes - can not | N/A |
| | Card | | redeem | redeem | |
| | Credit | 3,000 | No - can | Yes - can only | Redeem only |
| | Card | | redeem | redeem 10% | for travel |

| | |
|---|---|
| Pooled Rewards: | 51,000 |

It should be noted that the restriction rules discussed herein are exemplary, and other restriction rules may be set based on other criteria and/or factors.

At step 422, the reward account holder 105 (or another account holder of a linked account) makes a determination whether to redeem rewards. For example, the account holder can attempt to redeem reward points to receive an airline reward program into a roundtrip airline ticket.

If, at step 422, the determination is made to redeem rewards, the method proceeds to step 424. For example, an account holder may attempt to redeem pooled rewards for an airline ticket, or may attempt to redeem individual rewards for a gift certificate.

At step 424, the linking engine 155 accesses the restriction rules in the account files database 160.

At step 426, the linking engine 155 makes a determination whether the reward redemption is permitted under the restriction rules. To make the determination, the linking engine 155 compares the potential reward redemption, (which was described herein with reference to step 422), with the restriction rules stored in the account files database 160. The reward cannot be redeemed if it violates a restriction rule. For example, if the account holder attempts to redeem 10,000 pooled reward points, and the restriction rule applicable to that account holder restricts any redemption of pooled rewards, the reward redemption is not permitted.

If, at step 426, the linking engine 155 makes the determination that the reward redemption is approved, the method proceeds to step 428.

At step 428, the linking engine 155 redeems the reward points and updates the balance in the associated reward account, i.e. debits the account for the amount of reward points redeemed. For an exemplary embodiment, this redemption task is completed by subtracting points or currency that would be the first to expire, based on a “first to expire, first out” redemption model. The method then proceeds to step 212 of FIG. 2.

Referring back to step 406, if the linking engine 155 determines that the access to the selected account is not valid, the method proceeds to step 430.

At step 430, the reward account holder 105 cannot set restriction rules. The method then proceeds to step 212 of FIG. 2.

Referring back to step 408, if the reward account holder 105 makes the determination not to restrict access to an individual account, the method proceeds to step 412, and the method proceeds as previously described herein.

Referring back to step 412, if the reward account holder 105 makes the determination not to restrict access to pooled rewards, the method proceeds to step 416, and the method proceeds as previously described herein.

Referring back to step 416, if the reward account holder 105 makes the determination not to restrict access based on reward type, the method proceeds to step 420, and the method proceeds as previously described herein.

Referring back to step 422, if the determination is made not to redeem rewards, the method proceeds to step 212 of FIG. 2.

Referring back to step 426, if the linking engine 155 makes the determination that the reward redemption is not approved, the method proceeds to step 432.

At step 432, the linking engine 155 does not redeem the reward points, and the balances in the reward accounts remain unchanged. The method then proceeds to step 212 of FIG. 2.

FIG. 5 depicts a detailed process flow 212 for converting reward points in accordance with an exemplary embodiment of the present invention. Referring to FIGS. 1 and 5, a process for converting reward points can be described.

Rewards or “Points” can be converted from one kind of reward program to another. At step 502, a loyalty program administrator builds conversion tables 180. Conversion tables 180 contain a “liability ratio” for each of the financial accounts 102. The liability ratio is a number that typically varies by reward account. A liability ratio is determined by the rewards currency associated with the rewards program and the rewards account. Liability ratios can be used to mathematically determine how many reward points are converted from one reward program, associated with a particular financial account (such as account 102), to another.

The loyalty program administrator manages the account files database 160 and can update, change, and administer the data stored therein. The step of building the conversion tables 180 will be described in more detail herein below with reference to FIG. 6.

The process of converting rewards can be useful in a variety of situations. For example, if a person associated with a linked account is in need of 1,000 reward points in the form of miles, another linked account holder can use the conversion process described herein to redeem reward points (which may be part of a different loyalty reward program) to miles and transfer them to the other person's account. When making such conversions between different loyalty programs and/or different financial accounts 102, the conversion is not necessarily a 1:1 conversion. For example, 1,000 miles might equal 2,000 points. Thus, liability ratios are thus used herein to easily allow users to convert reward points among loyalty reward programs. It should be noted that conversions can take place between reward accounts held by different people, as well as reward accounts held by the same person.

At step 504, the reward account holder 105 selects a source account, from which the reward points will be deducted in order to be converted. When the reward account holder 105 logs in to the linking system 190, the user can select a source account from among the linked accounts, which were linked at step 206 of FIG. 3 and described herein with reference to FIG. 3.

At step 506, the reward account holder 105 selects a destination account, from which the converted reward points will be deposited. Again, the reward account holder 105 can select an account from among the linked accounts to be the “destination account.” A destination account is used herein to refer to the linked account which will be credited with reward points if the reward conversion takes place.

At step 508, the reward account holder 105 selects a reward transfer amount from the source account. For example, 10,000 points. The reward transfer amount is the amount of reward points which would be deducted from the source account when the conversion takes place.

At step 510, the linking engine 155 retrieves the liability ratio for each of the source account and the destination account from the conversion tables 180, which are stored in the account files database 160.

At step 512, the linking engine 155 calculates the converted transfer amount using liability ratios in the following formula (Equation 1):

Transfer amount (from source account)*(source account liability ratio/destination account liability ratio) Equation 1

As an example, if the transfer amount is 10,000 points, and the source account liability ratio is 1.05, and the destination account liability ratio is 0.95, the resulting converted transfer amount would be calculated as follows:

10,000*(1.05/0.95)=11,052

Thus, for this example, the converted transfer amount would equal approximately 11,052 points. Because the source account liability ratio is higher than the destination account liability ratio, the converted transfer amount is greater than the initial transfer amount in the source account.

As part of the conversion process, the expiration date for the original source account currency or points is typically carried forward for use with the resulting destination account currency. For example, if the source currency that is the subject of the conversion or transfer has an expiration date of Dec. 31, 2012, the conversion process generates destination currency having the same expiration date, namely Dec. 31, 2012.

The conversion tables can also include conversion fees. A conversion fee is a fee that is applied to a conversion. The conversion fee is typically determined by the financial institution associated with the financial account. The fee value can be supplied by the financial institution when it submits a transfer request to this product. Conversion fee ratios will be described in more detail herein with reference to FIG. 6.

At step 514, the linking engine 155 provides the reward account holder 105 with the converted destination amount (calculated at step 512) for approval. Here, the reward account holder 105 can determine whether to complete the transfer, i.e. whether the converted destination amount is sufficient, or if it is too high.

At step 516, the reward account holder 105 makes a determination whether to approve the conversion. For example, if the reward account holder 105 wanted to the converted destination amount to be 12,000 points, the amount in the example above would be insufficient, and the reward account holder 105 would not approve the conversion.

If, at step 516, the reward account holder 105 makes the determination to approve the conversion, the method proceeds to step 520.

At step 520, the linking engine 155 completes the conversion by updating the source account and destination account reward balances. The linking engine 155 debits the source account with the transfer amount selected at step 508, and credits the destination account with the converted destination account, calculated at step 512. The method then ends.

Referring back to step 516, if the reward account holder 105 makes the determination not to approve the transfer, the method proceeds to step 518.

At step 518, the linking engine 155 does not complete the conversion. The source account and destination account balances remain unchanged. The method then ends.

FIG. 6 depicts a detailed process flow 502 for building conversion tables in accordance with an exemplary embodiment of the present invention.

Referring now to FIG. 6, at step 602, the loyalty program administrator defines one liability ratio for each account in the program. As discussed above with reference to FIG. 5, a liability ratio is a number, which varies by reward account, but remains the same for each account whether it is designated as a “source” account or a “destination” account. Thus, by defining only one liability ratio for each reward account, the process of converting reward points is simplified.

At step 604, the loyalty program administrator stores the liability ratios in the conversion tables 180, which are typically stored in the account files database 160. An exemplary conversion table is illustrated below in Table 3.

TABLE 3

| Account | Liability Ratio | Conversion Fee Ratio |
|---|---|---|
| Credit program (Platinum) | 1.05 | .05 |
| Credit program (Gold) | 1.00 | .05 |
| Credit program (silver) | 0.95 | .05 |
| Debit program | 0.95 | .05 |
| HELOC program | 0.25 | .10 |
| Partner credit program | 0.75 | .20 |

The method then proceeds to step 504 of FIG. 5.

Although specific embodiments of the present invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed:

1. A method for linking loyalty reward accounts comprising the steps of:
a) receiving, by a computer-implemented linking engine, a selection of loyalty reward accounts from a loyalty reward account holder, wherein each account holder associated with the selection of loyalty reward accounts has a confirmed relationship with the other account holders, the relationship comprising at least one of: a family relationship, a business relationship, and a personal relationship;
b) validating, by the computer-implemented linking engine, the loyalty reward account holder's access to the selection of loyalty reward accounts;
c) in response to validating the loyalty reward account holder's access to the selection of loyalty reward accounts, assigning via the computer-implemented linking engine a unique cross-reference number to the selection of loyalty reward accounts;
d) pooling via the computer-implemented linking engine a balance of reward points associated with each of the selection of loyalty reward accounts assigned the unique cross-reference number, by combining the balance of reward points from each of the selection of loyalty reward accounts into a single balance of pooled reward points; and
e) storing, by the computer-implemented linking engine, the cross-reference number in association with each of the selection of loyalty reward accounts in a database.

2. The method of claim 1, wherein the linking engine is implemented in a computer system that comprises instructions stored in a machine-readable medium and a processor that executes the instructions.

3. The method of claim 1, further comprising the step of providing access to the cross-reference number to a loyalty reward program provider.

4. The method of claim 1, wherein the selection of loyalty reward accounts are associated with at least one loyalty reward program, wherein the loyalty reward program is an incentive program offered by the loyalty program provider, to incentivize predefined purchase behavior, and wherein the loyalty program provider grants reward points to the loyalty reward account holder that are redeemable for a reward offering by the loyalty program provider.

5. The method of claim 1, wherein the unique cross-reference number is sequentially assigned based on a previously assigned cross-reference number.

6. The method of claim 1, further comprising the steps of:
a) receiving instructions from the loyalty reward account holder, the instructions comprising a second loyalty reward account holder, a loyalty reward account associated with the second loyalty reward account holder and assigned the unique cross-reference number, and a restriction rule, wherein the restriction rule restricts the second loyalty reward account holder's ability to redeem reward points associated with the selection of loyalty reward accounts;
b) storing the restriction rule in the database;
c) in connection with a reward redemption made by the second loyalty reward account holder, determining whether the reward redemption is permitted under the restriction rule; and
d) in response to determining that the reward redemption is permitted under the restriction rule, performing the reward redemption.

7. The method of claim 6, wherein the reward redemption comprises exchanging reward points for the reward offering from the loyalty program provider.

8. The method of claim 6, wherein the restriction rule restricts the second loyalty reward account holder's ability to redeem reward points by one of: restricting redemption from an individual loyalty reward account associated with the second loyalty reward account holder; restricting redemption from the pooled reward points associated with the selection of loyalty reward accounts; and restricting redemption based on a reward type of the reward offering.

9. The method of claim 1, further comprising the steps of:
a) receiving instructions from the loyalty reward account holder, the instructions comprising a source loyalty reward account from the loyalty reward accounts assigned the unique cross-reference number, a destination loyalty reward account from the loyalty reward accounts assigned the unique cross-reference number, and a transfer reward amount;
b) calculating, using the transfer reward amount and a liability ratio for each of the source loyalty reward account and the destination loyalty reward account, a converted destination reward amount, wherein the liability ratio is a predetermined number assigned to each account of the plurality of loyalty reward accounts;
c) providing the converted destination reward amount to the loyalty reward account holder for approval;
d) in response to receiving approval from the loyalty reward account holder, debiting the source loyalty reward account by the transfer reward amount, and crediting the destination loyalty reward account by the converted destination reward amount.

10. The method of claim 9, wherein the liability ratio is the same whether the loyalty reward account is designated as the source loyalty reward account, or as the destination loyalty reward account.

11. The method of claim 9, wherein the transfer reward amount reflects an amount of reward points associated with a first loyalty reward program, and the converted destination reward amount reflects an amount of reward points associated with a second loyalty reward program.

12. A method for linking loyalty reward accounts comprising the steps of:
a) receiving, by a linking engine, instructions from a loyalty reward account holder, the instructions comprising a selection of loyalty reward accounts, wherein the loyalty reward account holder has a confirmed relationship to each account holder of the selection of loyalty reward accounts and the linking engine comprises a computer operable to execute instructions stored in a machine-readable medium.
b) assigning, by the linking engine, a unique cross-reference number to the selection of loyalty reward accounts, wherein the selection of loyalty reward accounts assigned the unique cross-reference number are linked accounts, linked accounts having a pooled reward point balance, wherein the pooled reward point balance comprises a total of a balance of reward points associated with each of the linked accounts; and
c) storing, by the linking engine, the unique cross-reference number in association with each of the linked accounts in a database.

13. The method of claim 12, wherein the confirmed relationship comprises at least one of: a family relationship, a business relationship, and a personal relationship.

14. The method of claim 12, wherein the unique cross-reference number is sequentially assigned based on a previously assigned cross-reference number.

15. The method of claim 12, further comprising the step of applying a restriction rule in connection with a reward redemption associated with the linked accounts, wherein the reward redemption is completed if it is permitted under the restriction rule.

16. The method of claim 15, wherein the reward redemption associated with the linked accounts comprises exchanging reward points for a reward offering by the loyalty program provider.

17. The method of claim 15, wherein the restriction rule restricts a loyalty reward account holder's ability to perform the reward redemption and is based on one or more of: restricting redemption of reward points from an individual linked account of the loyalty reward account holder; restricting redemption of pooled reward points from the linked accounts; and restricting redemption of reward points based on a type of the reward offering.

18. The method of claim 15, wherein the restriction rule is stored in the database.

19. The method of claim 12, further comprising the step of converting a transfer amount of reward points associated with a first loyalty reward program, to a converted destination amount of reward points associated with a second loyalty reward program.

20. The method of claim 19, further comprising the steps of:
a) receiving instructions from the loyalty reward account holder, the instructions comprising the transfer amount of reward points, a source loyalty reward account from the linked accounts, and a destination loyalty reward account from the linked accounts;
b) calculating the converted destination reward amount using a liability ratio for each of the source loyalty reward account and the destination loyalty reward account;
c) providing the converted destination reward amount to the loyalty reward account holder for approval; and
d) in response to approval from the loyalty reward account holder, debiting the source loyalty reward account by the transfer amount, and crediting the destination loyalty reward account by the converted amount.

21. The method of claim 19, wherein the liability ratio is a predetermined number assigned to each account of the plurality of loyalty reward accounts.

22. The method of claim 19, wherein the calculating step further comprises calculating a conversion fee by using a conversion fee ratio for each of the source loyalty reward account and the destination loyalty reward account.

23. An apparatus for linking reward accounts, comprising:
means for receiving instructions from a loyalty reward account holder, the instructions comprising a selection of loyalty reward accounts, wherein account holders of the selection of loyalty reward accounts are associated with the loyalty reward account holder through a confirmed relationship;
means for assigning a unique cross-reference number to the selection of loyalty reward accounts, the selection of loyalty reward accounts assigned the unique cross-reference number being linked accounts having a pooled reward point balance, wherein the pooled reward point balance comprises a total amount of points from each of the linked accounts;
means for receiving instructions from the loyalty reward account holder, the instructions defining a restriction rule, wherein the restriction rule defines the ability of an account holder associated with the linked accounts to redeem reward points associated with the linked accounts;
means for applying the restriction rule in connection with a reward redemption associated with the linked accounts; and
means for performing the reward redemption if the reward redemption is permitted under the restriction rule.

24. The apparatus of claim 23, wherein the confirmed relationship comprises at least one of: a family relationship, a business relationship, and a personal relationship.

25. The apparatus of claim 23, further comprising a database that stores the unique cross-reference number in association with the linked accounts, stores the restriction rule; and stores a conversion table comprising a liability ratio for each of the selection of loyalty reward accounts, wherein a liability ratio is a predetermined number assigned to each of the linked accounts.

26. The apparatus of claim 23, further comprising converting means for:
a) receiving instructions from the loyalty reward account holder, the instructions comprising a transfer amount of reward points, a source loyalty reward account from the linked accounts, and a destination loyalty reward account from the linked accounts;
b) calculating a converted destination reward amount using the liability ratio for each of the source loyalty reward account and the destination loyalty reward account;
c) providing the converted destination reward amount to the loyalty reward account holder for approval; and
d) in response to approval from the loyalty reward account holder, debiting the source loyalty reward account by the transfer amount, and crediting the destination loyalty reward account by the converted destination amount.

27. The apparatus of claim 26, wherein the transfer amount of reward points is associated with a first loyalty reward program, and the converted destination amount of reward points is associated with a second loyalty reward program.

28. The apparatus of claim 23, wherein the unique cross-reference number is sequentially assigned based on a previously assigned cross-reference number.

29. The apparatus of claim 23, wherein the restriction rule is based on one or more of: restricting redemption of reward points from an individual linked account of the loyalty reward account holder; restricting redemption of pooled reward points from the linked accounts; and restricting redemption of reward points based on a type of the reward offering.

30. The apparatus of claim 23, wherein the reward redemption comprises exchanging reward points for a reward offering from a loyalty program provider.
